(19) United States
(12) Patent Application Publication
(10) Pub. No.: US 2021/0233427 A1
(43) Pub. Date: Jul. 29, 2021

(54) SYSTEM AND METHODS FOR FACILITATING LANGUAGE LEARNING

(71) Applicant: Mooveez Company A.S., Prague (CZ)

(72) Inventors: Miroslav Pesta, Prague 10 (CZ); Karel Tomas, Prague 8 (CZ); Jiri Horak, Prague 10 (CZ)

(73) Assignee: Mooveez Company A.S., Prague (CZ)

(21) Appl. No.: 17/055,797

(22) PCT Filed: Jan. 11, 2019
(86) PCT No.: PCT/IB2019/050241

§ 371 Date: Nov. 16, 2020

Related U.S. Application Data
(60) Provisional application No. 62/674,804, filed on May 22, 2018.

(51) Int. Cl. G09B 19/06; G09B 19/04; G09B 5/06; G06F 3/0481; G06F 3/0484

(52) U.S. Cl. CPC G09B 19/06; G09B 19/04; G06F 3/04842; G06F 3/04817; G09B 5/065

(57) ABSTRACT

This disclosure provides methods and systems for facilitating learning through watching multimedia contents in a target language, learning words and grammatical rules in text transcripts presented in multiple forms including flashcards, and providing an accurate assessment of current linguistic knowledge of a learner in a language knowledge map.

### FIELD OF THE INVENTION

The invention relates generally to methods and systems for facilitating learning of a target (i.e., foreign) language, and more particularly to methods and systems for facilitating learning of a target language through watching multimedia contents in the foreign language, learning words and grammatical rules within text transcripts presented in multiple forms including flashcards, and providing an accurate assessment of current linguistic knowledge of a learner in a language knowledge map.

### BACKGROUND OF THE INVENTION

Bilingual or multilingual ability becomes increasingly important in the expanding global economy. A variety of methods (e.g., computerized methods) have been employed by teachers and researchers to improve teaching practices. Despite the rich interactive content incorporated into most computerized methods of foreign language instruction, learning foreign languages remains a difficult and painful task. Some methods utilize subtitles in motion pictures created in a target language to make the language learning experience more enjoyable and more culturally relevant. Generally, the script associated with a video or motion picture is translated into subtitles. The subtitles are synchronized with the audio dialogue as it naturally accompanies the visual content. Two types of subtitles are available, namely, hard and soft subtitles. Hard subtitles are embedded into the original material and cannot be turned off by the viewer. In contrast, soft subtitles are associated with the video from another data file, and can usually be turned on/off by the viewer. Although these methods increase the ease of learning a foreign language by leveraging subtitles in motion pictures, they still struggle to achieve efficacy. Learners of these methods are generally more engaged, but still, experience difficulty processing and committing new information to their memory. Importantly, effectiveness of these methods are often undermined by the lack of a method capable of accurately evaluating the current linguistic knowledge of a learner.

Accordingly, there is a continuing need to develop new and effective ways to teach and learn a foreign language. It is thus an aim of the present disclosure to provide a system and method for facilitating language learning through watching multimedia contents in a target language, learning words and grammatical rules in text transcripts presented in multiple forms including flashcards, and providing an accurate assessment of current linguistic knowledge of a learner in a language knowledge map.

### SUMMARY OF THE INVENTION

The present disclosure provides a method for facilitating language learning. The method includes presenting multimedia content on a display of a user device. The multimedia content includes one or more audiovisual segments, each of which is associated with a sentence or a portion of the sentence. The method also includes providing on the same display a first text transcript in a target language and a second text transcript in a source language corresponding to the sentence or the portion of the sentence associated with each of the audiovisual segments. The method also includes receiving one or more user responses from a user to the first text transcript in the target language associated with each of the audiovisual segments. The user responses indicate the user's comprehension of the first text transcript in the target language. The method further includes determining a linguistic knowledge of the user based on an aggregate analysis of the received one or more user responses to the first text transcript in the target language. The linguistic knowledge of the user is determined by a level of vocabulary or mastery of a grammatical rule. The method additionally includes generating a language knowledge map based on the linguistic knowledge of the user. The language knowledge map may include a plurality of cells representing words, phrases or grammatical rules. The method also includes displaying the language knowledge map on the user device.

In some embodiments, the method also includes receiving a user action selecting one of the plurality of cells. The user action is a request to display a content embedded in the selected cell. In some embodiments, the method further includes presenting the content embedded in the selected cell upon receiving the user action. The content may include a word displayed in the source language and/or the target language. In some embodiments, the method includes updating the language knowledge map based on the aggregate analysis of the received one or more user responses over a period of time or to a plurality of multimedia contents viewed by the user.

In some embodiments, the language knowledge map may further include a plurality of zones representing one or more levels of mastery of words and grammatical rules. The words and grammatical rules constitute the sentence or the phrase within the first text transcript in the target language. In some embodiments, the plurality of cells may include a color shading indicating a level of mastery of words or grammatical rules. In some embodiments, a combination of adjacent two or more cells of the plurality of cells in the language knowledge map represents one or more grammatical rules.

In some embodiments, the first text transcript in the target language is provided by a language professional. In some embodiments, the second text transcript in the source language is provided by a translation of the first text transcript in the target language. In some embodiments, the translation of the first text transcript in the target language is a verbatim translation or a colloquial translation.

In some embodiments, the one or more user responses may include a first user input responsive to a first icon indicating the user's comprehension of the first text transcript in the target language. The first user input is an indicia of a confirmation or a denial of the user's comprehension of the first text transcript in the target language. In some embodiments, the method further includes assigning a mastered status or an unmastered status to the first text transcript based on the first user input and assigning the mastered status or the unmastered status to the words and the grammatical rules within the text first transcript in the target language.

In one aspect, the one or more user responses may include a second user input responsive to a second icon indicating a user's request for creating a flashcard associated with the first text transcript in the target language or the second text transcript in the source language corresponding to an audiovisual segment. In some embodiments, the flashcard may include the first text transcript in the target language and the corresponding audiovisual segment. In some embodiments, the flashcard may include the first text transcript in the target language and the corresponding audiovisual segment. In some embodiments, the method includes assigning a flashcard type to the flashcard. The flashcard type to be assigned includes new flashcard type, favorite flashcard type, and revision flashcard type. In some embodiments, the flashcard may include additional information selected from the group consisting of usage frequency, usage time, and date of creation.

In another aspect, the method includes receiving a user action that is a request to toggle between a first flashcard having the first text transcript in the target language and a second flashcard having the second text transcript in the source language. The first text transcript and the second text transcript are associated with the same audiovisual segment. In some embodiments, the method also includes swapping the first text transcript with the second text transcript and displaying the second text transcript upon receiving the user action and when the first text transcript is currently displayed. In some embodiments, the method further includes swapping the second text transcript with the first text transcript and displaying the first text transcript, upon receiving the user action and when the second text transcript is currently displayed.

In some embodiments, the method includes receiving a user action responsive to the flashcard that is a request for playing the flashcard. The method includes playing, upon receiving the user action, an audio component of the audiovisual segment and the first text transcript in the target language associated with the audiovisual segment. In some embodiments, the method further includes automatically assigning the mastered status to the words and the grammatical rules within the first text transcript in the target language contained in the flashcard after repetition of playing the flashcard exceeds a predetermined number of times.

In some embodiments, the method includes receiving a third user input responsive to a third icon indicating the user's comprehension of the second transcript in the target language within the flashcard. The method also includes assigning the mastered status to the words and the grammatical rules within the text transcript.

In some embodiments, the method includes receiving a fourth user input responsive to a fourth icon that is a request to record a user's audio dictation for the audiovisual segment associated with the flashcard. The method includes acquiring an audio recording having the user's audio dictation for the audiovisual segment and associating the audio recording with the flash card.

In some embodiments, before presenting the multimedia content, the method includes providing information of one or more multimedia contents for selection by the user. The method also includes receiving a first user input indicating a selection of the one or more multimedia contents, a second user input indicating a selection of the source language, and a third user input indicating a selection of the target language. The method further includes delivering, to the user device, the one or more multimedia contents based on the first user input, the second user input, and the third user input by downloading or steaming the one or more multimedia contents. In some embodiments, the information of the one or more multimedia contents is a rating, a difficulty level, or a list of target languages available for the one or more multimedia contents. In some embodiments, the multimedia content is film, animation, video clip, or audio playback.

In some embodiments, the method includes generating a note frame having additional information corresponding to a word, a phrase, or a sentence within the text transcript. The method further includes displaying the note frame while pausing the multimedia content.

In some embodiments, the method includes providing a functional cover movable to an area on the display of the user device, so that the functional cover masks a portion of the first text transcript in the target language or the second text transcript in the source language. A movement of the functional cover causes the multimedia content to pause.

In some embodiments, the method includes providing one or more questions related to a content of the text transcript. The content may be a word, a phrase, a sentence, a grammatical rule or a combination of two or more thereof. The method also includes receiving a user input having answers to the one or more questions and determining the linguistic knowledge of the user based on the aggregate analysis of the received user input.

In some embodiments, the method includes receiving a user input having a rating of the multimedia content and generating an updated rating for the multimedia content based on the user input.

In some embodiments, the method includes receiving a user action directed to a character in the multimedia content. In some embodiments, the method also includes playing an audio component of the multimedia content associated with the character while pausing the video component of the multimedia content.

In some embodiments, the method includes displaying, upon receiving a user action to play the flashcard, a message that is an invitation of a practice to transcribe the audiovisual segment associated with the flashcard after a parameter of the flashcard exceeds a predetermined value. The method also includes receiving a user input that is indicative of an acceptance or a rejection of the invitation of the practice to transcribe the audiovisual segment. In some embodiments, the parameter of the flashcard is the number of repetitions that the flashcard has been played. In some embodiments, the parameter of the flashcard is a period of time lapsed since the flashcard is created. In some embodiments, the method further includes playing the audio component of the audiovisual segment and displaying the first text transcript in the target language upon determining that the user input is an acceptance of the invitation to transcribe the audiovisual segment. The method also includes receiving and displaying a dictation from the user corresponding to the played audio component or the displayed first text transcript in the target language. In some embodiments, the method additionally includes spell checking the dictation from the user.

In some embodiments, the method includes receiving a user selection that is a request to display the multimedia content in a full-screen mode. The method also includes playing the multimedia content in the full-screen mode while hiding the first text transcript and the second text transcript. In some embodiments, the method includes receiving a user action (e.g., taping) from the user on the display of the user device in response to a scene of the multimedia content. In some embodiments, the taping action from the user may continue longer than a preset period of time. In some embodiments, the method includes displaying a plurality of text transcripts in the target language that corresponds to the scene of the multimedia content while pausing the play of the multimedia content.

In some embodiments, the method includes receiving a user action (e.g., vertical sliding) from the user on the display of the user device in response to a scene of the multimedia content. The method includes displaying one or more text transcripts in the target language corresponding to earlier portions of the scene upon determining the vertical sliding action is an upward sliding action. The method also includes displaying one or more text transcripts in the target language corresponding to later portions of the scene upon determining the vertical sliding action is a downward sliding action.

In some embodiments, the method includes receiving a user action (e.g., horizontal sliding) from the user on the display of the user device in response to the scene of the multimedia content. The method also includes creating a new flash card containing the first text transcript in the target language. The method further includes assigning a new card status to the created flashcard and resuming playing the multimedia content.

This disclosure also provides a system for facilitating language learning. The system may present multimedia content on a display of a user device. The multimedia content includes one or more audiovisual segments, each of which is associated with a sentence or a portion of the sentence. The system may also provide on the same display a first text transcript in a target language and a second text transcript in a source language corresponding to the sentence or the portion of the sentence associated with each of the audiovisual segments. The system may further receive one or more user responses from a user to the first text transcript in the target language associated with each of the audiovisual segments. The user responses indicate the user's comprehension of the first text transcript in the target language. The system may also determine a linguistic knowledge of the user based on an aggregate analysis of the received one or more user responses to the first text transcript in the target language. The linguistic knowledge of the user is determined by a level of vocabulary or mastery of a grammatical rule. The system may create a language knowledge map based on the linguistic knowledge of the user. The language knowledge map may include a plurality of cells representing words, phrases or grammatical rules. The system may also display the language knowledge map on the user device.

### BRIEF DESCRIPTION OF DRAWINGS

The objects, features, and advantages of the present disclosure will be apparent from the following description of particular embodiments of those inventive concepts, as illustrated in the accompanying drawings. The drawings depict only typical embodiments of the present disclosure and, therefore, are not to be considered limiting in scope.

FIG. 1 shows an example of a method for selecting multimedia contents based on desired target and source languages.

FIG. 2 shows an example of a method for facilitating language learning which includes generating a language knowledge map that represents current linguistic knowledge of a user.

FIG. 3A shows partitioning of an audiovisual segment into objects (e.g., sentence) and/or elements (e.g., words).

FIG. 3B shows an example of presenting multimedia contents in a split-screen mode having text transcripts in target and source languages.

FIG. 4 shows an example of a method for facilitating language learning through receiving user responses to an “I Know” flag.

FIG. 5A shows an example of a language knowledge map which includes a plurality of cells and zones representing different levels of mastery of words and grammatical rules.

FIG. 5B shows a portion of a language knowledge map including a plurality of cells with color shading.

FIGS. 5C, 5D, and 5E show examples of a language knowledge map.

FIG. 5F shows an example of a language knowledge map with a content embedded in the cell displayed.

FIG. 6 shows an example of a method for facilitating language learning by using a flashcard.

FIG. 7 shows an example of a method for facilitating language learning by using a flashcard.

FIG. 8 shows an example of a method for facilitating language learning by recording a user's own audio dictation for a content in the flashcard.

FIG. 9 shows an example of a method for facilitating language learning by engaging a user to provide dictation for a content in the flashcard.

FIGS. 10A and 10B (collectively “FIG. 10”) show an example implementing the method illustrated in FIG. 9.

FIG. 11 shows an example of a method enabling a switch between a full-screen viewing mode and a split-screen mode.

FIGS. 12A, 12B, 12C, and 12D (collectively “FIG. 12”) show examples implementing the method illustrated in FIG. 11.

FIG. 13 shows an example of a method enabling on-screen viewing and operation of text transcripts.

FIGS. 14A, 14B, 14C and 14D (collectively “FIG. 14”) show examples implementing the method illustrated in FIG. 13.

FIG. 15 shows an example of a method enabling the on-screen creation of flashcards.

FIG. 16 shows examples implementing the method illustrated in FIG. 15.

FIG. 17 shows an example of a method for facilitating language learning by playing a dialogue associated with a character in the multimedia content.

FIG. 18 shows an example implementing the method illustrated in FIG. 17.

FIG. 19 shows an example of a functional cover.

FIG. 20 shows an example of a note frame.

FIG. 21 shows an exemplary system implemented for facilitating language learning.

FIG. 22 shows an exemplary computing device implemented for facilitating language learning.

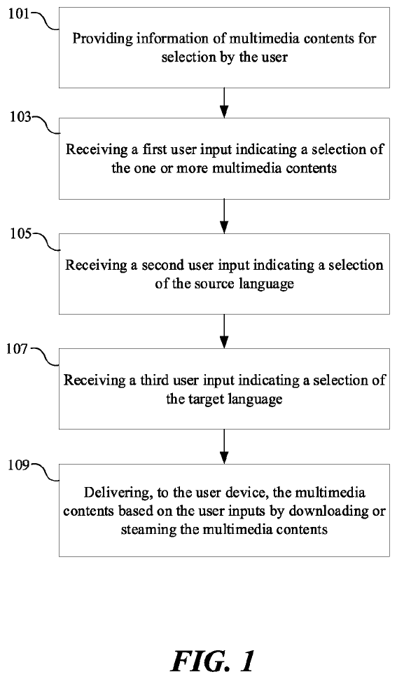

### DETAILED DESCRIPTION OF THE INVENTION

This disclosure is not limited to the particular systems, methodologies or protocols described, as these may vary. The terminology used in this description is to describe the particular versions or embodiments only and is not intended to limit the scope.

This disclosure describes a system and method for facilitating language learning. The system and method provides an effective way for learning a foreign language and a approach for evaluating linguistic knowledge of a learner accurately using a language knowledge map. The system and method engages learners by allowing them to choose a multimedia content with its original soundtrack and by leveraging text transcripts in target and source languages associated with the multimedia content. While watching the multimedia content, the system presents the learners text transcripts concurrently in target and source languages. Each text transcript corresponds to an audiovisual segment. The audiovisual segment can be associated with a sentence or a portion of a sentence. The text transcript in a target language (e.g., a foreign language) can be partitioned into phrases or words and include one or more grammatical rules. The system and method present the text transcripts to learners in multiple forms. In one example, the text transcripts are presented as subtitles displayed in a split-screen mode under the multimedia content. In another example, the text transcripts are presented in flashcards which allow learners to review the text transcripts without replaying the media contents. In addition, elements of the text transcriptions, such as words, phrase, and grammatical rules can be presented for review in a language knowledge map. Through interactions responsive to these multiple forms of text transcripts in a target language, learners can review text transcripts repetitively and indicate whether they have comprehended the text transcripts. The system can determine a linguistic knowledge of the user based on an aggregate analysis of the user responses to the text transcript in the target language. The linguistic knowledge of the user may include a level of vocabulary and/or mastery of a grammatical rule. Based on the linguistic knowledge of the user, the system may generate a language knowledge map that includes a plurality of cells representing words, phrases, or grammatical rules.

Before presenting multimedia content, the method may start at 101 with providing information of one or more multimedia contents for selection by the user. The multimedia content can be defined as any recorded production containing a video portion and a synchronized audio dialog portion in a target or source language. In some embodiments, the multimedia content is a film, an animation, a video clip, or an audio playback. The target language as used herein refers to a foreign language a user desires to learn. The source language as used herein refers to a native language of the user or a language in which the user is fluent. The multimedia content may include text transcripts in both target and source languages. The text transcripts may be soft subtitles (i.e., softsubs or closed subtitles). Such text transcripts in the form of soft subtitles are separate instructions, usually a specially marked up text with timestamps to be displayed during playback. In some embodiments, it is possible to have multiple concurrent language subtitles associated with a single multimedia content.

In some embodiments, the information of the multimedia contents may include, without limitation, title, rating, difficulty level, review, released year, size, or a list of target languages in which subtitles are available. The method also includes receiving a first user input indicating a selection of the multimedia contents at 103, a second user input indicating a selection of the source language at 105, and a third user input indicating a selection of the target language at 107. At 109, the method further includes delivering, to the user device, the multimedia contents based on the first, second, and third user inputs by downloading or streaming the multimedia contents. Examples of the user device may include, without limitation, a computer system such as a desktop computer, notebook or laptop computer, netbook, a tablet computer, e-book reader, handheld electronic device, cellular telephone, smartphone, other suitable electronic devices, or any suitable combination thereof. As understood by one of ordinary skill in the art, any suitable communication networks, via any suitable connections, wired or wirelessly, and in any suitable communication protocols, can be used to deliver the multimedia contents. Examples of suitable communication networks include, without limitation, Local Area Networks (LAN), Wide Area Networks(WAN), telephone networks, the Internet, or any other wired or wireless communication networks.

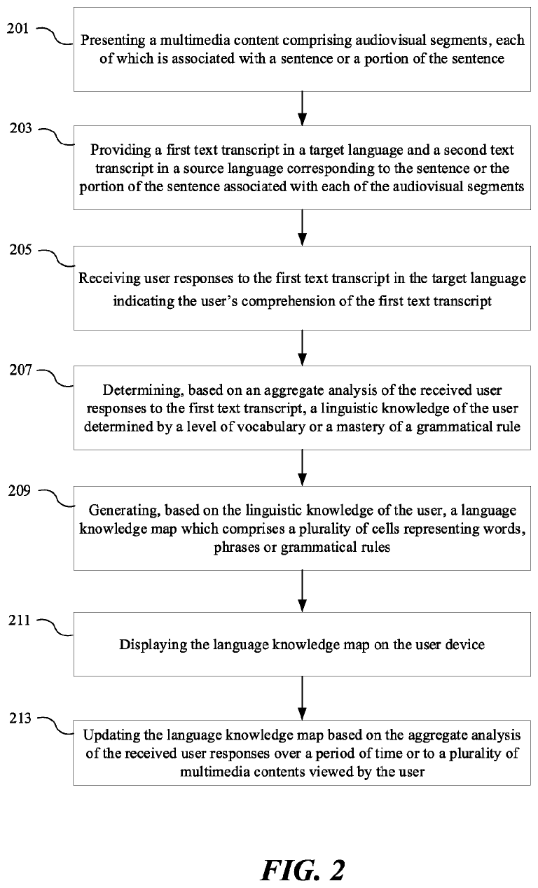

FIG. 2 illustrates a method for facilitating language learning. The method begins at 201 by presenting multimedia content on a display of a user device. The multimedia content may include, without limitation, a film, an animation, a video clip, or an audio playback. In some embodiments, the multimedia content includes a film with a soundtrack in the original language and a text transcript of the movie dialogues. Films presented to the user may contain colloquial language that roughly corresponds to the style and scope of the common language. The frequency vocabulary of films is very similar to the frequency vocabulary of the spoken word. Therefore, films can be used as a reference file of the language (e.g., vocabulary, sentences and phrases, use of grammatical rules) to gauge a learner's current linguistic knowledge.

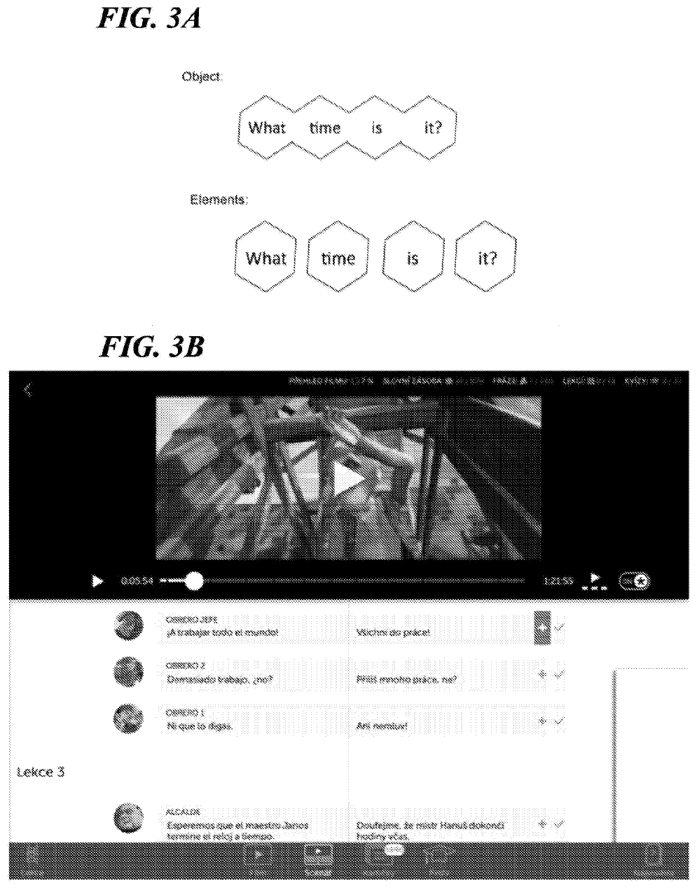

The multimedia content includes one or more audiovisual segments, each of which is associated with a sentence or a portion of the sentence in a dialogue. In one example, the multimedia content is segmented into audiovisual clips based on the audio profiles corresponding to individual sentences or phrases. A timestamp is assigned to each phrase or sentence by a professional and well-trained person. The time stamp can then be used to segment the video content within the multimedia content, such that the audio segment and the video segment share the same timestamp (i.e., the same start and end times) and are synchronized. For example, the film is divided by time stops into film segments that correspond to individual sentences or parts of sentences. Film segments are separate entities that can be viewed or played outside the film Film segments may include image, sound and the pertinent text transcript. Three types of linguistic elements may be extracted from film segments, including sentence, word, and use of grammar Sentences can be further partitioned into words. In implementing the disclosed method, each film segment is assigned to an object, which includes image, sound, and related text transcript. The object can be further partitioned to smaller elements, such as sentences, words, and grammatical rules, as shown in FIG. 3A. Each element carries information including: which object it belongs to, the translation in another language, and other information, including user's rating, whether the user comprehends the element or not.

The method continues at 203 with providing on the same display a first text transcript in a target language and a second text transcript in a source language corresponding to the sentence or the portion of the sentence associated with each of the audiovisual segments, as shown in FIG. 3B. In some embodiments, the target language is a foreign language that a user intends to learn, and the source language is the language in which the user is fluent. As described above, during the process of selecting a multimedia content for viewing, the user may choose a multimedia content with desired target and source languages. In some embodiments, the first transcript in the target language is provided by a language professional. In some embodiments, the second text transcript in the source language is provided by a translation of the first text transcript in the target language. In some embodiments, the second text transcript in the source language is provided by machine translation or human translation. In some embodiments, the translation of the first text transcript in the target language is a verbatim translation or a colloquial translation.

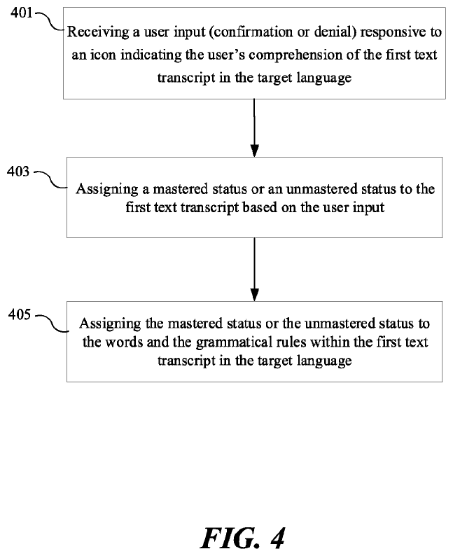

At 205, the method also includes receiving one or more user responses to the first text transcript in the target language associated with each of the audiovisual segments. The user responses indicate the user's comprehension of the first text transcript in the target language. For example, as shown in FIG. 4, at 401 the method includes receiving the one or more user responses containing a first user input responsive to an icon. The icon may include an “I Know” flag. The first user input responsive to the icon indicates the user's comprehension of the first text transcript in the target language. In some embodiments, the first user input is an indicia of a confirmation or a denial of the user's comprehension of the first text transcript in the target language. At 403, the method further includes assigning a mastered status or an unmastered status to the first text transcript based on the first user input. Because the text transcript may include one or more sentences corresponding to an audiovisual segments, it can be further partitioned into phrases and words. Accordingly, at 405 the method may also assign the mastered status or the unmastered status to the words and the grammatical rules within the text first transcript in the target language. Alternatively, in the event that the user determines a further review or practice on the first text transcript in the target language is needed, he/she may create a flashcard containing the first text transcript in the target language. The user may continue to work with the flashcard in a repetitive fashion. The creation and use of the flashcard to facilitate the learning of a foreign language is described in greater detail in the later sections of this disclosure.

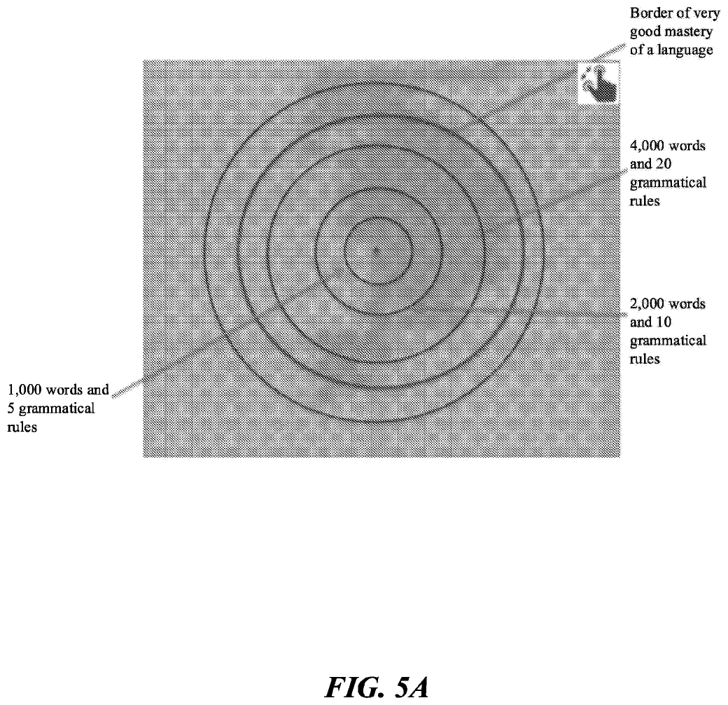

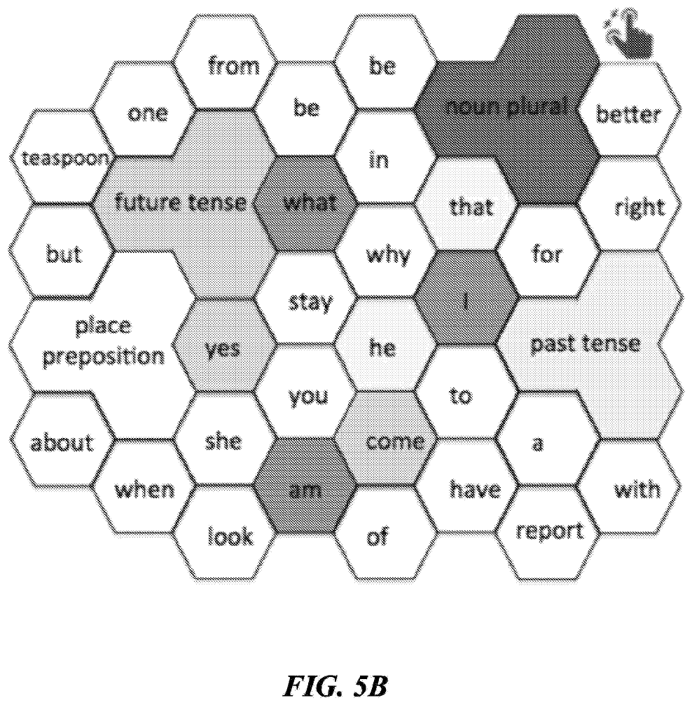

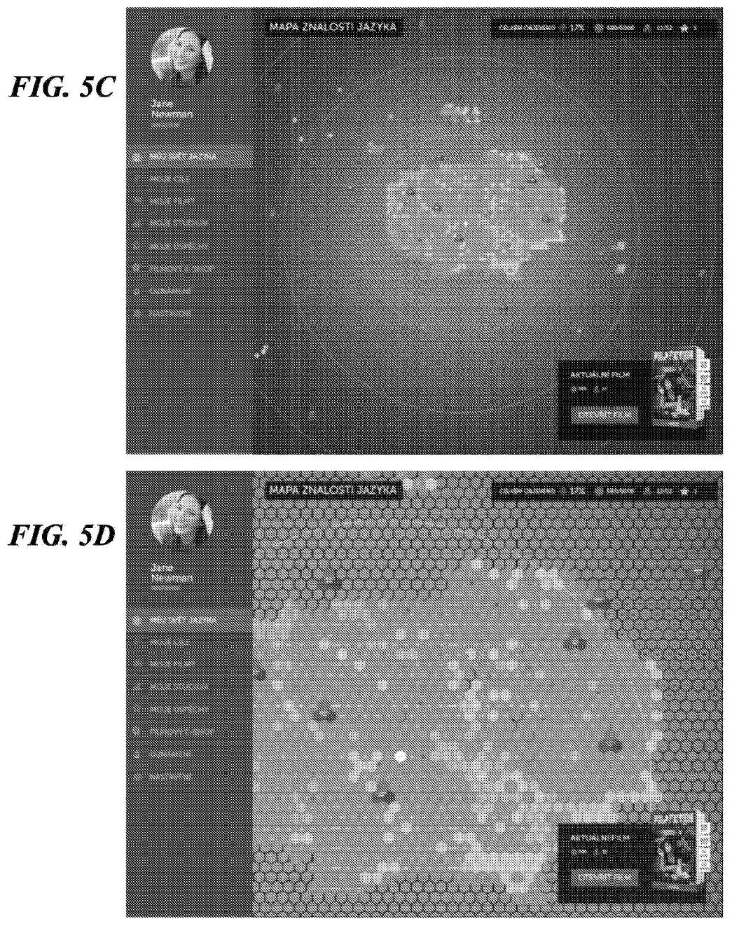

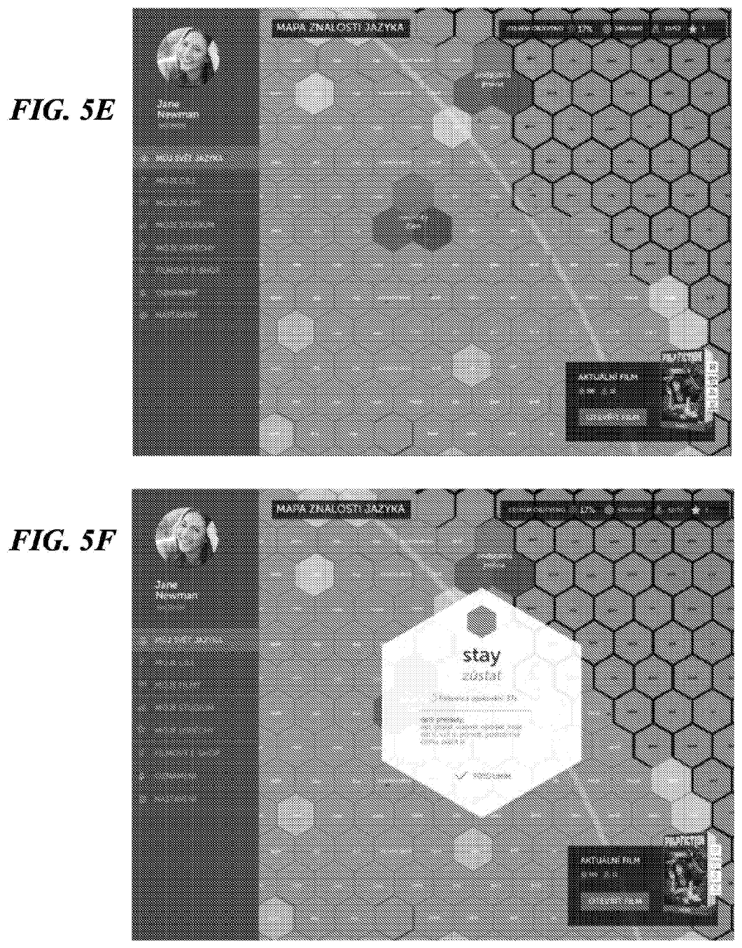

The method continues at 207 with determining a linguistic knowledge of the user based on an aggregate analysis of the received one or more user responses to the first text transcript in the target language. The linguistic knowledge of the user is determined by a level of vocabulary or mastery of a grammatical rule. At 209, the method additionally includes generating a language knowledge map based on the linguistic knowledge of the user. Examples of the language knowledge map are shown in FIGS. 5A-5F. The language knowledge map may include a plurality of cells representing words, phrases, or grammatical rules. FIG. 5B shows a portion of the language knowledge map consisting of a plurality of cells that represent words and grammatical rules. Cells that make up the language knowledge map may have any shapes, including without limitation, circular, elliptical, square, rectangular, and polygonal, quadrilateral, square, triangular, parallelogram, pentagonal, hexagonal, heptagonal and octagonal. As shown in FIG. 5B, the language map may be honeycomb-shaped, constituted by a number of hexagonal shaped cells. Within the language map, each cell may present a word. A combination of adjacent two or more cells of the plurality of cells in the language knowledge map may represent one or more grammatical rules.

Additionally, cells may further include a color shading indicating a level of mastery of words or grammatical rules, as shown in FIG. 5B. For example, the relative lightness or darkness of color may correspond to the number of times that a word, a phrase, or a grammatical rule has been reviewed by the user. In one example, no color shading indicates that a word, a phrase, or a grammatical rule has not been reviewed by the user, a light green shading indicates that a word, a phrase, or a grammatical rule has been reviewed 5-19 times by the user, and a dark green shading indicates that a word, a phrase, or a grammatical rule has been reviewed at least 20 times by the user. The user may review the word, phrase, or grammatical rule by reading the first text transcript in the target language, by playing flashcards, or by viewing the word, phrase, or grammatical rule embedded in a cell. Alternatively, the color shading of cells can be used to reflect the user's activities with flashcards. For example, a light color shading may indicate that a word, a phrase, or a grammatical rule is in the process of teaching with flashcards but has not been through full repetition. A dark color shading, however, may indicate that a word, a phrase, or a grammatical rule has been through the process of teaching with flashcards or labeled by the user as mastered.

The language knowledge map may additionally include a plurality of zones representing one or more levels of mastery of words and grammatical rules, as shown in FIG. SA. The zones encompass cells representing words and grammatical rules of the sentence or phrases within the first text transcript in the target language. FIG. 4A illustrates an exemplary language map including serval zones in the form of circles with different sizes. However, it would be understood by one of ordinary skill in the art that any shape may be used to represent a zone. The shapes can be used to represent zones include, without limitation, circular, elliptical, square, rectangular, and polygonal, quadrilateral, square, triangular, parallelogram, pentagonal, hexagonal, heptagonal and octagonal. Zones with varying sizes include different numbers of words, phrases, and grammatical rules. In one example, as shown in FIG. 4A, an inner zone may represent a low mastery level of 1,000 words and 5 grammatical rules, and outer zones may present increasing mastery levels of 2,000 words and 10 grammatical rules, and 4,000 words and 20 grammatical rules. One or more such zones on the language knowledge map may be characterized as a good mastery of the target language. For example, depending on the complexity of the target language, a master level of 4,000 words and 20 grammatical rules can be characterized as a good mastery of the language. In some embodiments, the method includes displaying the language knowledge map on the user device at 211. In some embodiments, the method may including storing the generated language knowledge map. In some embodiments, the system may update the language knowledge map based on the aggregate analysis of the received one or more user responses over a period of time or to a plurality of multimedia contents viewed by the user.

The language knowledge map is not only a tool to accurately evaluate, monitor, and display the current linguistic knowledge of a foreign language for a user, but also an interactive interface to learn the foreign language. For example, in some embodiments, the method also includes receiving a user action selecting one of the plurality of cells, as shown in FIG. 5F. The user action indicates a request to display a content embedded in the selected cell. For example, the user may touch any cell within the language knowledge map. Upon receiving the user action, the method includes presenting the content embedded in the selected cell. The content may include a word, a phrase, or a grammatical rule displayed in the target language and/or the source language. In some embodiments, the system may receive a user action (e.g., long press on a cell) that is a request to display additional information about the word, the phrase, or the grammatical rule. The additional information may include a translation of the word, the phrase, or the grammatical rule in the source language. Upon receiving such user action, the method may include displaying the additional information of the word, the phrase, or the grammatical rule in an magnified cell. In some embodiments, in reviewing the content embedded in the cell of the language knowledge map, the user may indicate that he/she has mastered the content (e.g., work, phrase, grammatical rule) by a user input. Accordingly, the system will update the language knowledge map based on the user input.

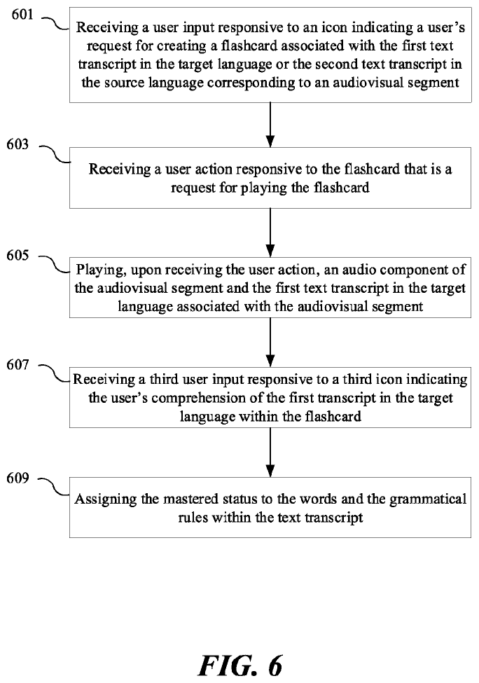

The disclosure also provides a method for facilitating learning of a foreign language by way of flashcards. Flashcards can be created while the user is viewing the multimedia content. When the user determines that he/she has not fully comprehended the first text transcript in the target language, the user may create a flashcard for a specific text transcript in the target language. The flashcard may contain additional information related to the text transcript. The additional information may include usage frequency, usage time, language, and date of creation. In some embodiments, the flash card may contain the text transcript in the target language and/or the source language. The flash card may also contain one more audio or video components of the audiovisual segment associated with the text transcript. In addition, the flashcard may further contain an audio recording of the user indicating the user's understanding of the text transcript. FIG. 6 shows a method for creating and playing flashcards. The method begins at 601 with receiving a second user input responsive to an icon indicating a user's request for creating a flashcard associated with the first text transcript in the target language or the second text transcript in the source language corresponding to an audiovisual segment. In some embodiments, the flashcard may include the first text transcript in the target language and the corresponding audiovisual segment. In some embodiments, the flashcard may include the second text transcript in the source language and the corresponding audiovisual segment. In some embodiments, the method includes assigning a flashcard type to the flashcard. The assignment of the flashcard types allow the user to categorize and organize the existing flashcards in individual folders. The flashcard type to be assigned includes new flashcard type, favorite flashcard type, and revision flashcard type. In some embodiments, the flashcard may include additional information selected from the group consisting of usage frequency, usage time, and date of creation. In some embodiments, the method may include ordering the existing flashcards based on one or more criteria. The criteria may include, date of creation, times being played, language, flashcard type, and duration of the associated audiovisual component. In some embodiments, the method may include shuffling through the existing flashcards one by one.

In some embodiments, the method includes receiving a user action that is a request to toggle between a first flashcard having the first text transcript in the target language and a second flashcard having the second text transcript in the source language. The first text transcript and the second text transcript are associated with the same audiovisual segment. In some embodiments, the method also includes swapping the first text transcript with the second text transcript and displaying the second text transcript upon receiving the user action and when the first text transcript is currently displayed. In some embodiments, the method further includes swapping the second text transcript with the first text transcript and displaying the first text transcript, upon receiving the user action and when the second text transcript is currently displayed.

Repetitive viewing or playing of flashcards in the target and/or source language helps the user develop full comprehension of the text transcript associated with the flashcards. At 603, the method includes receiving a user action responsive to the flashcard that is a request for playing the flashcard. According to the Ebbinghaus forgetting curve, after a certain number of repetitions, the user would eventually reach a full comprehension level of the text transcript. Accordingly, the flashcard is marked as learned and deleted from the storage. At 605, the method includes playing, upon receiving the user action, an audio component of the audiovisual segment and the first text transcript in the target language associated with the audiovisual segment. At 607, the method includes receiving a third user input responsive to a third icon indicating the user's comprehension of the first transcript in the target language within the flashcard. At 609, the method also includes assigning the mastered status to the words and the grammatical rules within the text transcript. Based on the user's responses indicating the mastered or unmastered status of words, phrases, or grammatical rules, the method may include updating the language map to reflect the current knowledge of a foreign language by the user.

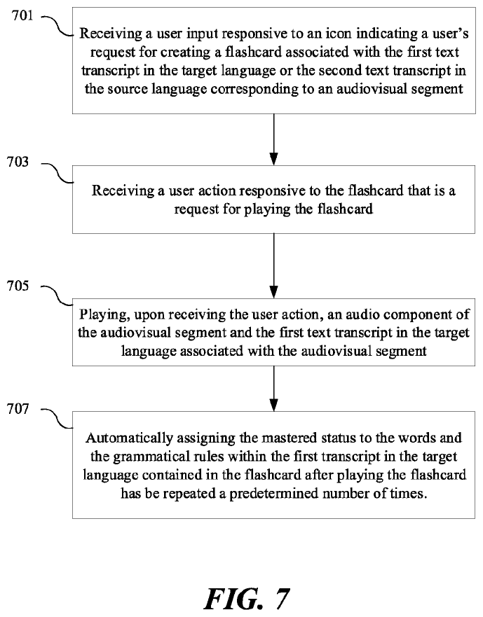

As shown in FIG. 7, following the creation of the flash card at 701, the method continues at 703 with receiving a user action responsive to the flashcard that is a request for playing the flashcard. At 705, the method includes playing, upon receiving the user action, an audio component of the audiovisual segment and the first text transcript in the target language associated with the audiovisual segment. At 707, the method further includes automatically assigning the mastered status to the words and the grammatical rules within the first transcript in the target language contained in the flashcard after repeating the step of playing the flashcard a predetermined number of times.

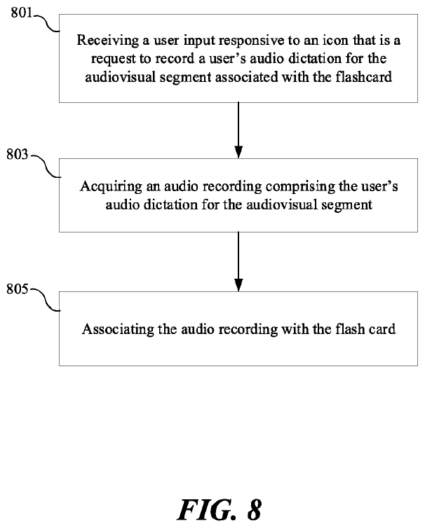

In some embodiments, the method may include receiving a user action responsive to an icon that is a request to delete a flashcard. In some embodiments, as shown in FIG. 8, the method includes receiving a user action responsive to an icon that is a request to record a user's audio dictation for the audiovisual segment associated with the flashcard, at 801. The user may provide the recording in the target language or the source language. In some embodiments, the recording is limited to a predetermined period of time (e.g., 30 seconds, 1 minute). The method may continue at 803 with acquiring an audio recording having the user's audio dictation for the audiovisual segment and associating the audio recording with the flash card at 805. After the audio recording is associated with the flash card, the method may include receiving a user action for playing the recorded audio dictation. In some embodiments, the method may permit multiple user recordings for one flashcard. In some embodiments, the method may include replacing a previously recorded audio dictation with a newly recorded audio dictation.

If some audio cards remain in repetitions longer than for a prescribed time: (e.g., a week after its creation), the user will be prompted by a notification during the next entry into the audio card section. The notification may include a message, such as, “It seems that some of the phrases are difficult for you to remember. Do you wish to create a dictation using these cards? Listening and transcribing will help you a lot in your learning.” The users may select “YES” and then be redirected to an exercise containing the assignment to transcribe crucial phrases. The user may select “NO,” and then the notification will no longer appear on these cards.

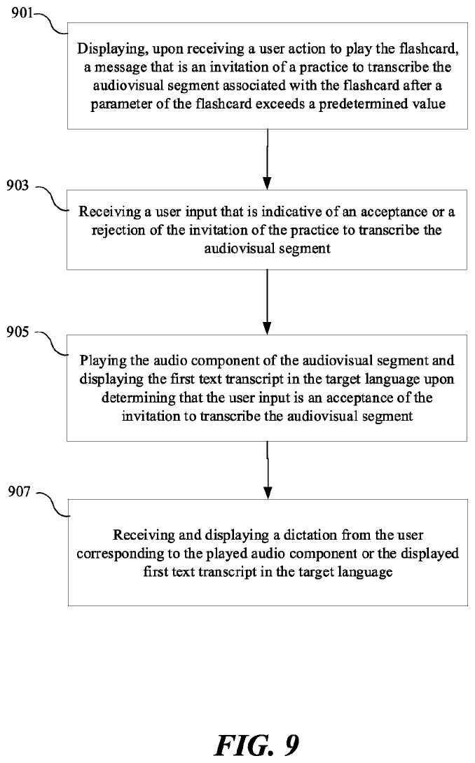

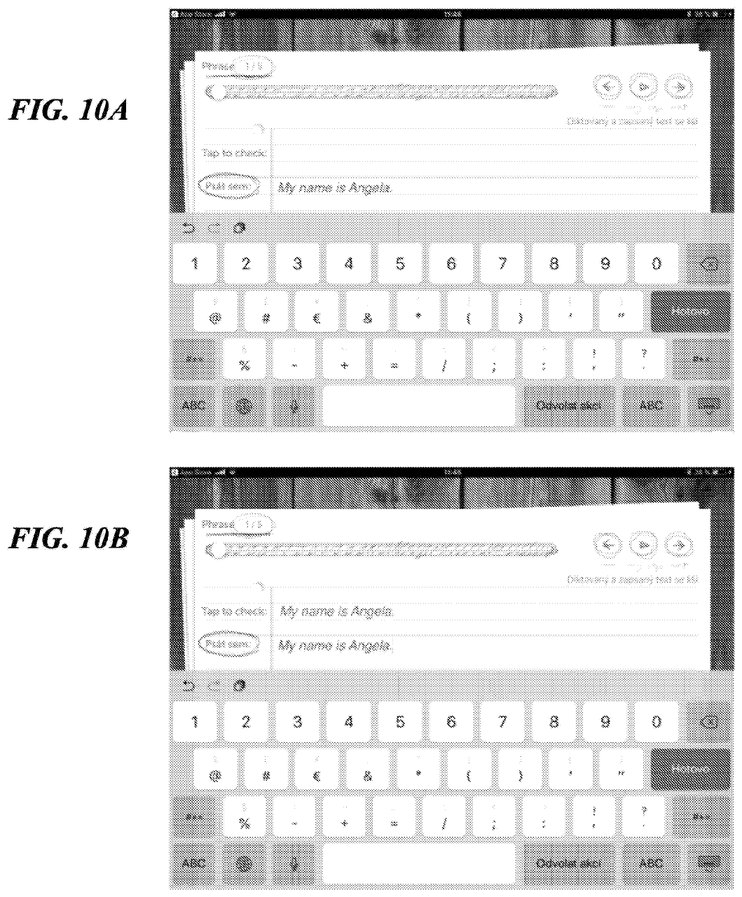

As shown in FIG. 9, the method may begin at 901 with displaying, upon receiving a user action to play the flashcard, a message that is an invitation to practice transcribing the audiovisual segment associated with the flashcard after a parameter of the flashcard exceeds a predetermined value. At 903, the method also includes receiving a user input that is indicative of an acceptance or a rejection of the invitation of the practice to transcribe the audiovisual segment. In some embodiments, the parameter of the flashcard is the number of repetitions that the flashcard has been played. In some embodiments, the parameter of the flashcard is a period of time lapsed (e.g., 1 week, 2 weeks, 1 month) since the flashcard is created. In some embodiments, the parameter of the flashcard is the number of repetitions (e.g., 5 times, 10 times, 20 times) that the flashcard has been played. In some embodiments, the method further includes playing the audio component of the audiovisual segment and displaying the first text transcript in the target language upon determining that the user input is an acceptance of the invitation to transcribe the audiovisual segment at 905. A shown in FIGS. 10A and 10B, the method continues at 907 with receiving and displaying a dictation from the user corresponding to the played audio component or the displayed first text transcript in the target language. In some embodiments, the method additionally includes spell checking the dictation from the user.

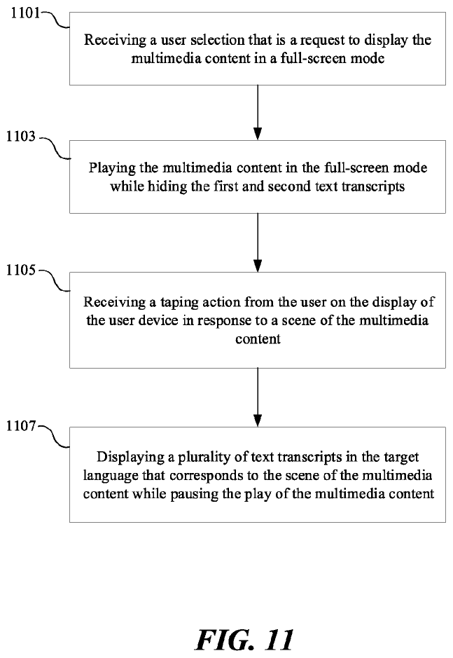

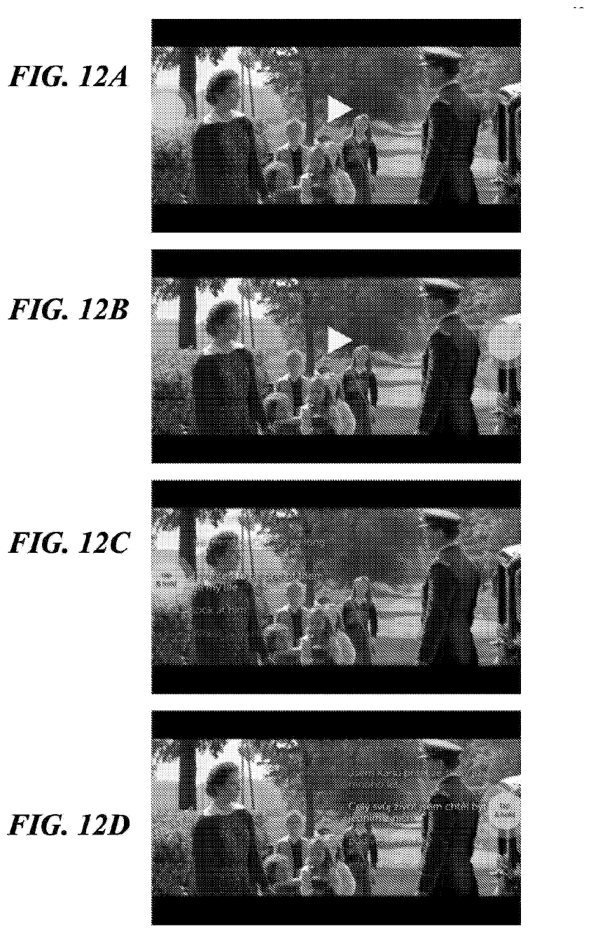

FIG. 11 illustrates a method for switching between a full-screen viewing mode and a split-screen viewing mode. The method may begin at 1101 with receiving a user selection that is a request to display the multimedia content in a full-screen mode. The method may continue at 1103 with playing the multimedia content in the full-screen mode while hiding the first and second text transcripts. On the other hand, if the user does not fully understand the meaning of a sentence in a plot, he/she may tap the screen with a long press, for example, in the right or left corner of the screen. The method may include receiving a taping action from the user on the display of the user device in response to a scene of the multimedia content at 1105. The method may continue at 1107 with displaying a plurality of text transcripts in the target language and/or the source languages that corresponds to the scene of the multimedia content while pausing the play of the multimedia content. In one configuration for implementing the disclosed method, the method may include providing the first text transcript in the target language upon receiving a user action (e.g., taping and/or long press) on the left portion of the screen, as shown in FIGS. 12A and 12C. In some embodiments, the method may include providing the second transcript in the source language upon receiving a user action (e.g., taping and/or long press) on the right portion of the screen, as shown in FIGS. 12B and 12D. When the user taps a touch screen, the image pauses, and the corresponding text transcripts appear at the bottom of the split screen.

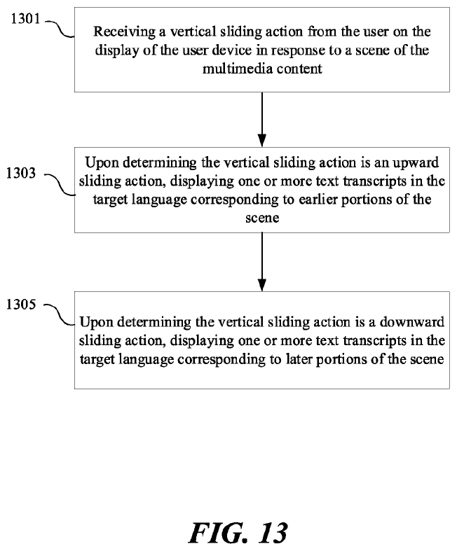

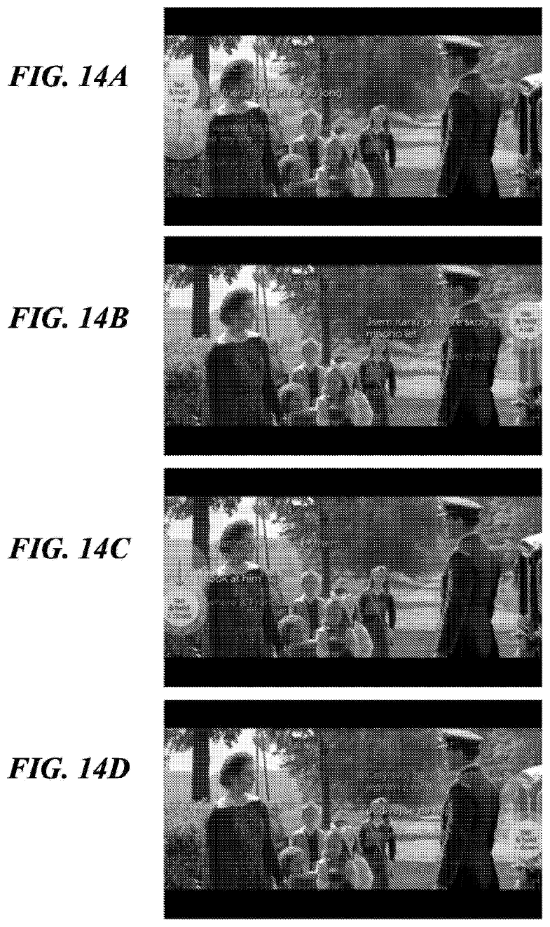

In addition, the user may view the previous and following text transcripts above or below the present text transcript. The present text transcript and the previous and following text transcripts may be presented in different colors for ease of reading. This configuration enables the users to move and display previous or subsequent subtitles with a simple figure gesture, for example, swiping with a thumb. When the user lifts the thumb, a full-screen playback mode resumes. As shown in FIG. 13, the method may include receiving a vertical sliding action from the user on the display of the user device in response to a scene of the multimedia content at 1301. The method includes displaying one or more text transcripts in the target language corresponding to earlier portions of the scene upon determining the vertical sliding action is an upward sliding action at 1303. The method also includes displaying one or more text transcripts in the target language corresponding to later portions of the scene upon determining the vertical sliding action is a downward sliding action at 1305.

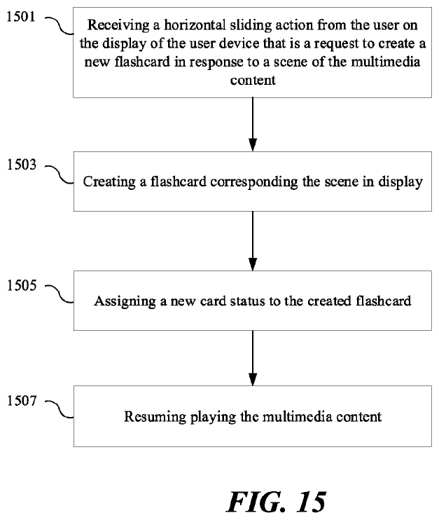

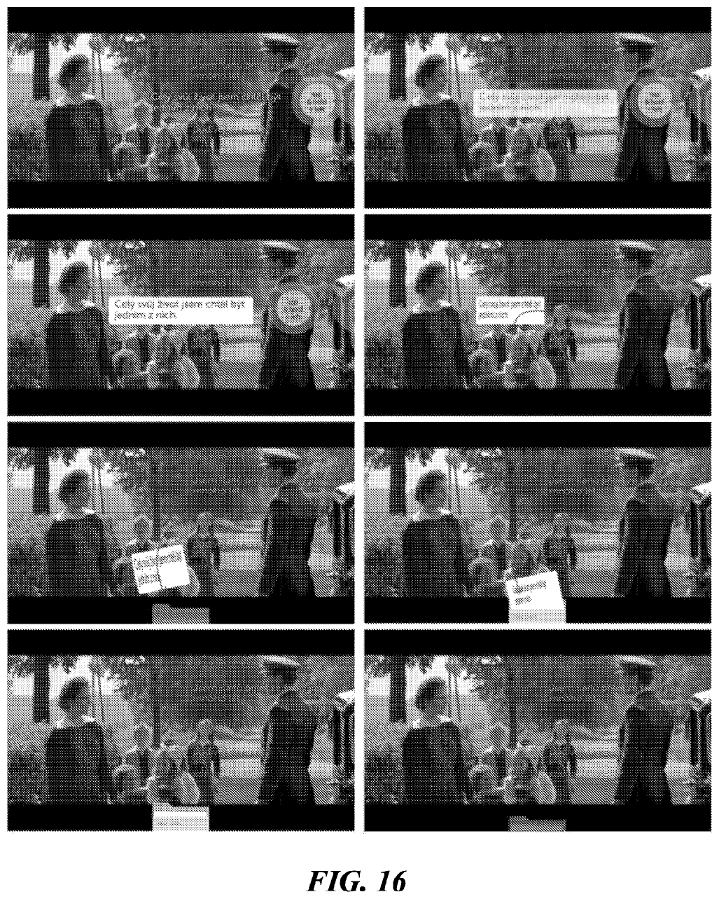

FIGS. 15 and 16 illustrate a method for creating a flashcard while viewing the multimedia content in a full-screen mode. The method begins at 1501 with receiving a horizontal sliding action from the user on the display of the user device that is a request to create a new flashcard containing the text transcript in the target language corresponding to the scene of the multimedia content. The method continues at 1503 with creating a flashcard containing the text transcript in the target language and assigning a new card status to the created flashcard at 1505. When the user lifts a finger, the method continues at 1507 with resuming playing the multimedia content.

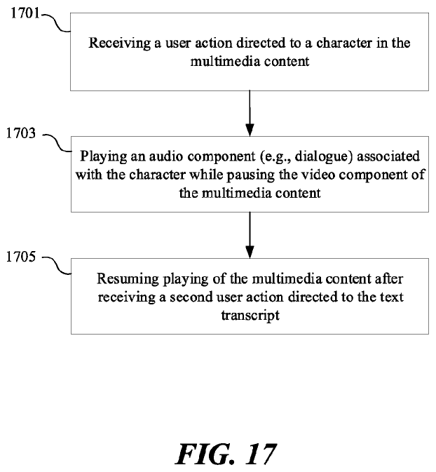

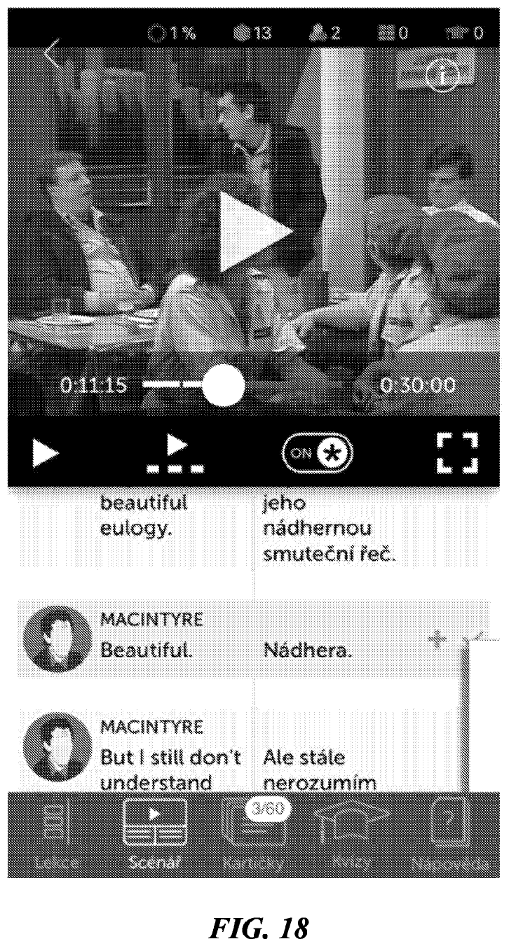

FIGS. 17 and 18 illustrate a method for facilitating language learning by replaying a dialogue by a character in the scene. For example, when the user may touch the icon of a character, the phrase or sentence in the dialogue will replay and stop before the next dialogue. The multimedia content may resume playing when the user touches the text transcripts. The text transcripts associated with dialogues can be scrolled freely for selection. When a text transcript corresponding to a dialogue is selected, the multimedia content will be synchronized to play the audiovisual segment that corresponds to the selected text transcript. As shown in FIG. 17, the method may begin at 1701 with receiving a user action directed to a character in the multimedia content. At 1703, the method also includes playing an audio component of the multimedia content associated with the character while pausing the video component of the multimedia content. At 1705, the method continues with resuming playing of the multimedia content after receiving a second user action directed to the text transcript.

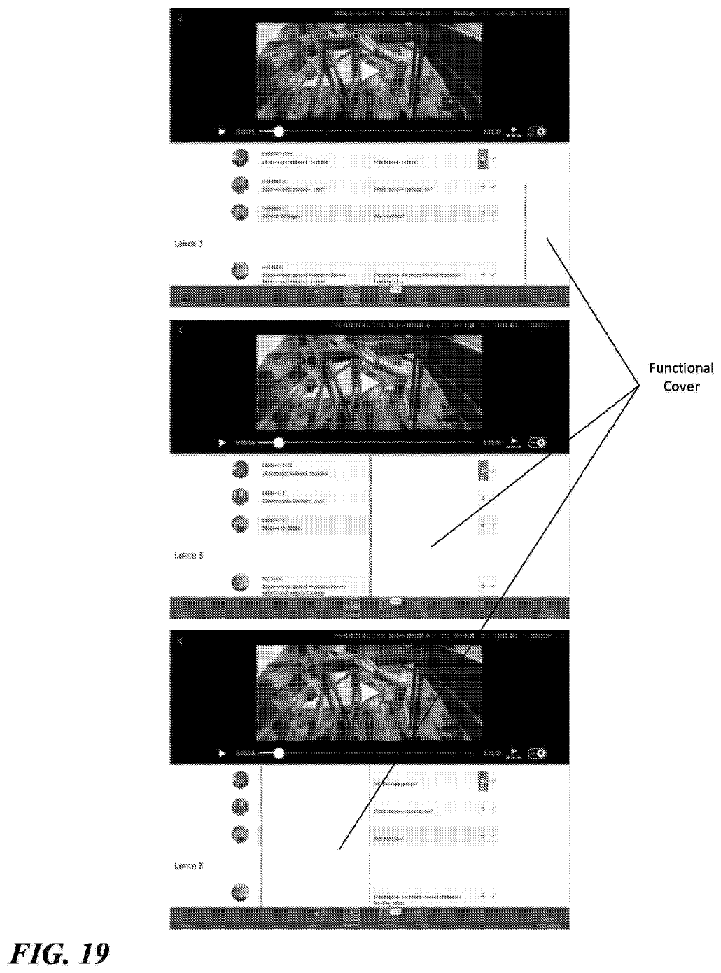

This disclosure also presents a method for facilitating language learning by providing a functional cover, as shown in FIG. 19. The functional cover may be a simulated white paper that can be used to mask a content of the first text transcript in the target language and/or the second text transcript in the source language. For example, the functional cover originally located in the lower right corner can be taken out and moved so as to cover the original text or the translation. In addition, the functional cover can be used to control the playing of the multimedia content based on the position in the display of the user device that the functional cover is located. For example, when the film is playing, taking out the cover will pause playing the multimedia content, whereas returning the functional cover back to the bottom right corner will resume playing the multimedia content.

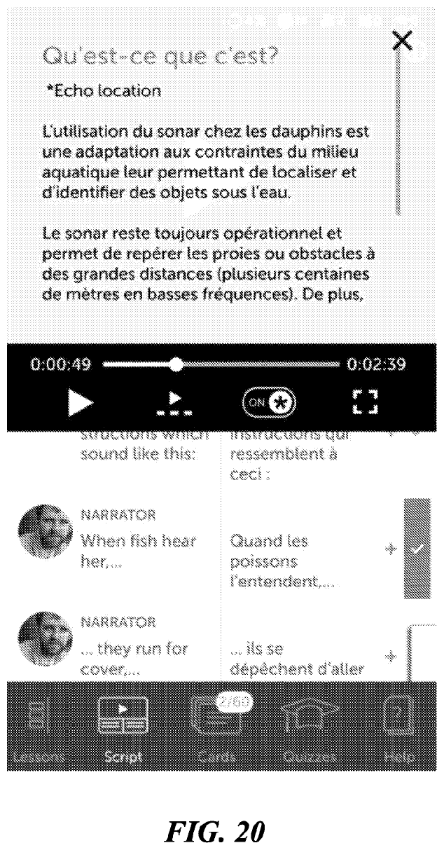

As shown in FIG. 20, a note frame (or note page) is illustrated. The note frame provides additional information corresponding to a word, a phrase, or a sentence within the text transcript. For example, the note frame may contain a detailed explanation in the source language for a word, a term, a phrase, or a sentence present in the multimedia content. The method further includes displaying the note frame while pausing the multimedia content. After reviewing the content in the note frame, the user may close the note frame so that playing of the multimedia content can be resumed.

This disclosure also presents a method for facilitating language learning by providing quizzes to the user. The method includes providing one or more questions related to a content of the text transcript. The content may be a word, a phrase, a sentence, a grammatical rule or a combination of two or more thereof. The method also includes receiving a user input having answers to the one or more questions and determining the linguistic knowledge of the user based on the aggregate analysis of the received user input.

According to one aspect of this disclosure, the method includes receiving a user input having a rating of the multimedia content and generating an updated rating for the multimedia content based on the user input.

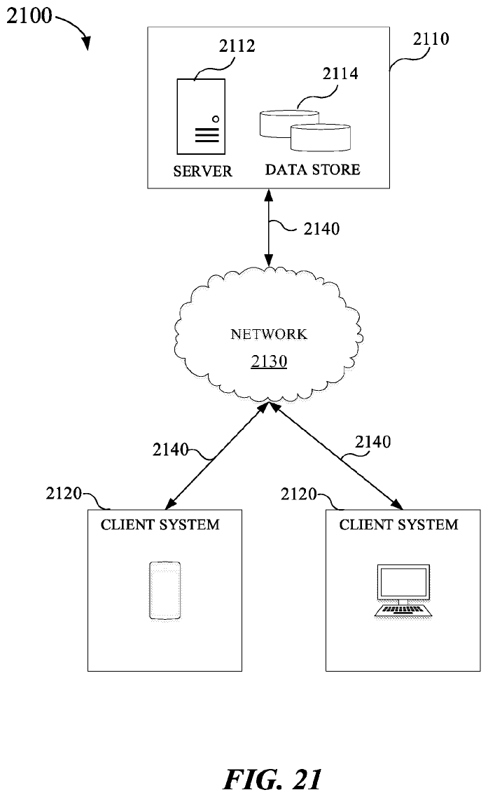

FIG. 21 illustrates an example of a system 2100 for implementing the disclosed methods. The system may include one or more internet-based server systems 2110 that are capable of communicating with one or more client systems 2120 via communication network 2130. Although FIG. 21 illustrates a particular arrangement of server systems 2110, client systems 2120, and network 2130, this disclosure contemplates any suitable arrangement of server systems, client systems, and network. As an example and not by way of limitation, one or more server of devices and one or more of client systems 2120 may be connected to each other directly, bypassing network 2130. As another example, two or more of client systems 2120 and one or more of server systems 2160 may be physically or logically co-located with each other in whole or in part. Moreover, although FIG. 21 illustrates a particular number of client systems 2120 and server systems 2110 and networks 2140, this disclosure contemplates any suitable number of client systems 2120 and server systems 2110 and networks 2130.

The server systems 2110 may be coupled to any suitable network 2130. As an example and not by way of limitation, one or more portions of network 2130 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 2130 may include one or more networks 2130.

Links 2140 may connect client systems 2120 and server system 2110 to communication network 2130 or to each other. This disclosure contemplates any suitable links 2140. In particular embodiments, one or more links 2140 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 2140 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 2140, or a combination of two or more such links 2140. Links 2140 need not necessarily be the same throughout network environment 2100. One or more first links 2140 may differ in one or more respects from one or more second links 2140.

In some embodiments, the server system 2110 may generate, store, receive and send data, such as, for example, user profile data, concept-profile data, social-networking data, or other suitable data. Server system 2110 may be accessed by the other components of system 2100 either directly or via network 2130. In particular embodiments, server system 2110 may include one or more servers 2112. Each server 2112 may be a unitary server or a distributed server spanning multiple computers or multiple datacenters. Servers 2112 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 2112 may include hardware, software, or embedded logic components or a combination of two or more such components for carrying out the appropriate functionalities implemented or supported by server 2112. In particular embodiments, server system 2110 may include one or more data stores 2114. Data stores 2114 may be used to store various types of information. In particular embodiments, the information stored in data stores 2114 may be organized according to specific data structures. In particular embodiments, each data store 2114 may be a relational, columnar, correlation, or other suitable databases. Although this disclosure describes or illustrates particular types of databases, this disclosure contemplates any suitable types of databases. Particular embodiments may provide interfaces that enable a server system 2110 and a client system 2120 to manage, retrieve, modify, add, or delete, the information stored in data store 2114.

In some embodiments, client system 2120 may be an electronic device including hardware, software, or embedded logic components or a combination of two or more such components and capable of carrying out the appropriate functionalities implemented or supported by client systems 2120. As an example and not by way of limitation, a client system 2120 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 2120. A client system 2120 may enable a network user at client system 2120 to access network 2130. A client system 2120 may enable its user to communicate with other users at other client systems 2120.

In some embodiments, client system 2120 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 2120 may enter a Uniform Resource Locator (URL) or other address directing the web browser to a particular server (such as server 2112), and the web browser may generate a Hyper Text Transfer Protocol (HTTP) request and communicate the HTTP request to the server. The server may accept the HTTP request and communicate to client system 2120 one or more Hyper Text Markup Language (HTML) files responsive to the HTTP request. Client system 2120 may render a webpage based on the HTML files from the server for presentation to the user. This disclosure contemplates any suitable webpage files. As an example and not by way of limitation, web pages may render from HTML files, Extensible HyperText Markup Language (XHTML) files, or Extensible Markup Language (XML) files, according to particular needs. Such pages may also execute scripts such as, for example, and without limitation, those written in JAVASCRIPT, JAVA, MICROSOFT SILVERLIGHT, combinations of markup language and scripts such as AJAX (Asynchronous JAVASCRIPT and XML), and the like. Herein, a reference to a webpage encompasses one or more corresponding webpage files (which a browser may use to render the webpage) and vice versa, where appropriate.

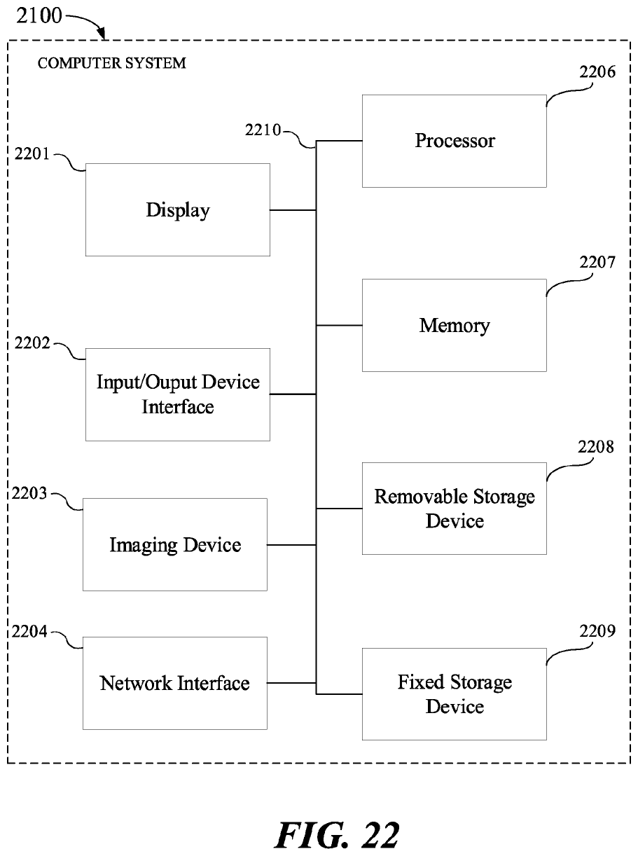

FIG. 22 is a functional diagram illustrating a programmed computer system for image processing in accordance with some embodiments. As will be apparent, other computer system architectures and configurations can be used to perform the described image processing technique. Computer system 2100, which includes various subsystems as described below, includes at least one microprocessor subsystem (also referred to as a processor or a central processing unit (CPU) 2206). For example, processor 2206 can be implemented by a single-chip processor or by multiple processors. In some embodiments, processor 2206 is a general purpose digital processor that controls the operation of the computer system 2100. In some embodiments, processor 2206 also includes one or more coprocessors or special purpose processors (e.g., a graphics processor, a network processor, etc.). Using instructions retrieved from memory 2207, processor 2206 controls the reception and manipulation of input data received on an input device (e.g., image processing device 2203, I/O device interface 2202), and the output and display of data on output devices (e.g., display 2201).

Processor 2206 is coupled bi-directionally with memory 2207, which can include, for example, one or more random access memories (RAM) and/or one or more read-only memories (ROM). As is well known in the art, memory 2207 can be used as a general storage area, a temporary (e.g., scratch pad) memory, and/or a cache memory. Memory 2207 can also be used to store input data and processed data, as well as to store programming instructions and data, in the form of data objects and text objects, in addition to other data and instructions for processes operating on processor 2206. Also as is well known in the art, memory 2207 typically includes basic operating instructions, program code, data, and objects used by the processor 2206 to perform its functions (e.g., programmed instructions). For example, memory 2207 can include any suitable computer-readable storage media described below, depending on whether, for example, data access needs to be bi-directional or uni-directional. For example, processor 2206 can also directly and very rapidly retrieve and store frequently needed data in a cache memory included in memory 2207.

A removable mass storage device 2208 provides additional data storage capacity for the computer system 2100, and is optionally coupled either bi-directionally (read/write) or uni-directionally (read-only) to processor 2206. A fixed mass storage 2209 can also, for example, provide additional data storage capacity. For example, storage devices 2208 and/or 2209 can include computer-readable media such as magnetic tape, flash memory, PC-CARDS, portable mass storage devices such as hard drives (e.g., magnetic, optical, or solid state drives), holographic storage devices, and other storage devices. Mass storages 2208 and/or 2209 generally store additional programming instructions, data, and the like that typically are not in active use by the processor 2206. It will be appreciated that the information retained within mass storages 2208 and 2209 can be incorporated, if needed, in standard fashion as part of memory 2207 (e.g., RAM) as virtual memory.

In addition to providing processor 2206 access to storage subsystems, bus 2210 can be used to provide access to other subsystems and devices as well. As shown, these can include a display 2201, a network interface 2204, an input/output (I/O) device interface 2202, an image processing device 2203, as well as other subsystems and devices. For example, image processing device 2203 can include a camera, a scanner, etc.; I/O device interface 2202 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 2100. Multiple I/O device interfaces can be used in conjunction with computer system 2100. The I/O device interface can include general and customized interfaces that allow the processor 2206 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 2204 allows processor 2206 to be coupled to another computer, computer network, or telecommunications network using a network connection as shown. For example, through the network interface 2204, the processor 2206 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 2206 can be used to connect the computer system 2100 to an external network and transfer data according to standard protocols. For example, various process embodiments disclosed herein can be executed on processor 2206 or can be performed across a network such as the Internet, intranet networks, or local area networks, in conjunction with a remote processor that shares a portion of the processing. Additional mass storage devices (not shown) can also be connected to processor 2206 through network interface 2204.

In addition, various embodiments disclosed herein further relate to computer storage products with a computer-readable medium that includes program code for performing various computer-implemented operations. The computer-readable medium includes any data storage device that can store data which can thereafter be read by a computer system. Examples of computer-readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system as shown in FIG. 22 is but an example of a computer system suitable for use with the various embodiments disclosed herein. Other computer systems suitable for such use can include additional or fewer subsystems. In some computer systems, subsystems can share components (e.g., for touchscreen-based devices such as smartphones, tablets, etc., I/O device interface 2202 and display 2201 share the touch-sensitive screen component, which both detects user inputs and displays outputs to the user). In addition, bus 2210 is illustrative of any interconnection scheme serving to link the subsystems. Other computer architectures having different configurations of subsystems can also be utilized.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

Other objects, features, and advantages of the present invention will become apparent from the following detailed description. It should be understood, however, that the detailed description and the examples, while indicating specific embodiments of the invention, are given by way of illustration only. Additionally, it is contemplated that changes and modifications within the spirit and scope of the invention will become apparent to those skilled in the art from this detailed description.

1. A method for facilitating language learning, comprising:
presenting, on a display of a user device, a multimedia content comprising one or more audiovisual segments, wherein each of the audiovisual segments is associated with a sentence or a portion of the sentence;
providing, on the same display, a first text transcript in a target language and a second text transcript in a source language corresponding to the sentence or the portion of the sentence associated with each of the audiovisual segments;
receiving one or more user responses from a user to the first text transcript in the target language associated with each of the audiovisual segments, wherein the user responses indicate the user's comprehension of the first text transcript in the target language;
determining a linguistic knowledge of the user based on an aggregate analysis of the received one or more user responses to the first text transcript in the target language, wherein the linguistic knowledge of the user is determined by a level of vocabulary or a mastery of a grammatical rule;
generating a language knowledge map based on the linguistic knowledge of the user, wherein the language knowledge map comprises a plurality of cells representing words, phrases or grammatical rules; and
displaying the language knowledge map on the user device.

2. The method of claim 1, wherein the language knowledge map further comprises a plurality of zones representing one or more levels of mastery of words and grammatical rules, wherein the words and grammatical rules constitute the sentence or the phrase within the first text transcript in the target language.

3. The method claim 1, wherein the plurality of cells comprises a color shading indicating a level of mastery of words or grammatical rules.

4. The method of claim 1, wherein a combination of adjacent two or more cells of the plurality of cells in the language knowledge map represents one or more grammatical rules.

5. The method of claim 1, further comprising:
receiving a user action selecting one of the plurality of cells, wherein the user action is a request to display a content embedded in the selected cell; and
presenting the content embedded in the selected cell upon receiving the user action, wherein the content comprises a word displayed in at least one of the source language and the target language.

6. The method of claim 1, further comprising:
updating the language knowledge map based on the aggregate analysis of the received one or more user responses over a period of time or to a plurality of multimedia contents viewed by the user.

7. The method of claim 1, where the first text transcript in the target language is provided by a language professional or by a translation of the first text transcript in the target language.

8. (canceled)

9. (canceled)

10. The method of claim 1, wherein the one or more user responses comprise a first user input responsive to a first icon indicating the user's comprehension of the first text transcript in the target language, wherein the first user input is an indicia of a confirmation or a denial of the user's comprehension of the first text transcript in the target language and wherein said method further comprises:
assigning a mastered status or an unmastered status to the first text transcript based on the first user input; and
assigning the mastered status or the unmastered status to the words and the grammatical rules within the text first transcript in the target language.

11. The method of claim 1, wherein the one or more user responses comprise a second user input responsive to a second icon indicating a user's request for creating a flashcard associated with the first text transcript in the target language or the second text transcript in the source language corresponding to an audiovisual segment and wherein the flashcard comprises the first text transcript in the target language and the corresponding audiovisual segment and the second text transcript in the source language and the corresponding audiovisual segment.

12. (canceled)

13. (canceled)

14. (canceled)

15. The method of claim 11, further comprising:
receiving a user action responsive to the flashcard that is a request for playing the flashcard; and
playing, upon receiving the user action, an audio component of the audiovisual segment and the first text transcript in the target language associated with the audiovisual segment.

16. The method of claim 15, further comprising:
automatically assigning the mastered status to the words and the grammatical rules within the first transcript in the target language contained in the flashcard after repeating the step of playing the flashcard a predetermined number of times.

17. The method of claim 11, further comprising:
receiving a third user input responsive to a third icon indicating the user's comprehension of the first transcript in the target language within the flashcard; and
assigning the mastered status to the words and the grammatical rules within the text transcript.

18. The method of claim 11, further comprising:
receiving a fourth user input responsive to a fourth icon that is a request to record a user's audio dictation for the audiovisual segment associated with the flashcard;
acquiring an audio recording comprising the user's audio dictation for the audiovisual segment; and
associating the audio recording with the flash card.

19. (canceled)

20. (canceled)

21. The method of claim 1, wherein the method comprises, before the step of presenting the multimedia content:
providing information of one or more multimedia contents for selection by the user;
receiving a first user input indicating a selection of the one or more multimedia contents;
receiving a second user input indicating a selection of the source language;
receiving a third user input indicating a selection of the target language; and
delivering, to the user device, the one or more multimedia contents based on the first user input, the second user input, and the third user input by downloading or steaming the one or more multimedia contents.

22. (canceled)

23. (canceled)

24. (canceled)

25. The method of claim 1, further comprising providing a functional cover movable to an area on the display of the user device, so that the functional cover masks a portion of the first text transcript in the target language or the second text transcript in the source language, wherein a movement of the functional cover causes the multimedia content to pause.

26. The method of claim 1, further comprising:
providing one or more questions related to a content of the text transcript, wherein the content is a word, a phrase, a sentence, a grammatical rule or a combination of two or more thereof;
receiving a user input comprising answers to the one or more questions; and
determining the linguistic knowledge of the user based on the aggregate analysis of the received user input.

27. (canceled)

28. (canceled)

29. The method of claim 11, further comprising:
displaying, upon receiving a user action to play the flashcard, a message that is an invitation of a practice to transcribe the audiovisual segment associated with the flashcard after a parameter of the flashcard exceeds a predetermined value; and
receiving a user input that is indicative of an acceptance or a rejection of the invitation the practice to transcribe the audiovisual segment.

30. (canceled)

31. (canceled)

32. The method of claim 29, further comprising:
playing the audio component of the audiovisual segment and displaying the first text transcript in the target language upon determining that the user input is an acceptance of the invitation to transcribe the audiovisual segment; and
receiving and displaying a dictation from the user corresponding to the played audio component or the displayed first text transcript in the target language.

33. (canceled)

34. (canceled)

35. The method of claim 134, further comprising:
receiving a taping action from the user on the display of the user device in response to a scene of the multimedia content, wherein the taping action from the user continues longer than a preset period of time; and
displaying a plurality of text transcripts in the target language that corresponds to the scene of the multimedia content while pausing the play of the multimedia content.

36. (canceled)

37. (canceled)

38. A system for facilitating language learning, comprising:
a non-transitory, computer readable memory;
one or more processors; and
a computer-readable medium containing programming instructions that, when executed by the one or more processors, cause the system to:
present, on a display of a user device, a multimedia content comprising one or more audiovisual segments, wherein each of the audiovisual segments is associated with a sentence or a portion of the sentence;
provide, on the same display, a first text transcript in a target language and a second text transcript in a source language corresponding to the sentence or the portion of the sentence associated with each of the audiovisual segments;
receive one or more user responses from a user to the first text transcript in the target language associated with each of the audiovisual segments, wherein the user responses indicate the user's comprehension of the first text transcript in the target language;
determine a linguistic knowledge of the user based on an aggregate analysis of the received one or more user responses to the first text transcript in the target language, wherein the linguistic knowledge of the user is determined by a level of vocabulary or a mastery of a grammatical rule;
generate a language knowledge map based on the linguistic knowledge of the user, wherein the language knowledge map comprises a plurality of cells representing words, phrases or grammatical rules; and
display the language knowledge map on the user device.
